(19) United States
(12) Patent Application Publication
(10) Pub. No.: US 2023/0143911 A1
(43) Pub. Date: May 11, 2023

(54) MATH STRATEGY GAME

(71) Applicant: Cassandra Oh, West Covina, CA (US)

(72) Inventor: Cassandra Oh, West Covina, CA (US)

(21) Appl. No.: 17/972,346

(22) Filed: Oct. 24, 2022

Related U.S. Application Data
(60) Provisional application No. 63/277,107, filed on Nov. 8, 2021.

(51) Int. Cl. A63F 9/00; A63F 11/00

(52) U.S. Cl. CPC A63F 9/0098; A63F 11/0011; A63F 13/80; A63F 2011/0016

(57) ABSTRACT

A math game is played by one or more players where the first player to reach a predetermined number wins the game. The game takes turn providing the players with a randomly picked number from a set of numbers or a choice option, and the player given the choice option can choose any one of the numbers from the set of numbers or zero that will give that player the best chance to be first to reach or not reach the predetermined number.

### BACKGROUND OF THE INVENTION

### 1. Related Applications

This application claims priority to a U.S. Provisional Application Serial No. 63/277,107, filed Nov. 8, 2021, entitled Math Strategy Game, which is hereby incorporated by reference.

### FIELD OF THE INVENTIONS

A math game includes an apparatus that can be used by one or more players following a set of rules where the first player to state a predetermined number as dictated by the rules wins the game; and in particular, the parameters of the math game may be different for each game, and outcome of the math game may involve elements of chance and skill such that a player with better skill may not win a game but as the game is played repeatedly, the player with better skill should win more often than not versus a lesser skilled player.

### BACKGROUND OF THE INVENTIONS

The following background discussion is not an admission that the matters discussed below are citable as prior art or common general knowledge. Rather, the general background information disclosed herein is directed to describing the problem(s) associated with the current state of the art, and the need for a better solution.

Math games can make learning math fun for kids; and for older adults, the math games can help the players keep their minds active and improve their cognitive skills. There are different types of math games where players can play alone or against another player(s), and/or against a computer running an algorithm with a set of rules. With a multi-players math game, once a player understands the rules that govern the game, a backward induction method may be implemented to formulate a strategy that allows the player to win the math game against a player who has not implemented such a backward induction method. However, if both players implement the backward induction method, then the math game becomes a simple irritative process where the outcome may be known even before the game starts; thus, making the game less interesting and fun.

For example, the twenty-one (21) math game (hereinafter “21 Game”) is a simple two persons game that allows a player that goes second to win every time if this player applies the backward induction method without making an unintentional mistake. The goal of the 21 Game is to be the first person to say “21” where the rule is that both players can only add 1 or 2 to whatever the other player says. For instance, the first player can say “1” or “2”, and based on the rule, the second player can say “3” or “4” and so on. In this 21 Game, a player can apply the backward induction method to figure out how to play this game and win. As an example, starting from the end, if the first player can get the second player to say 19 or 20, then the first player can win by adding 1, and saying “21”; and therefore continuing to work backward, the first player can win if she can say “18”, which means the second player needs to say “16” or “17”, so if the first player can say “15” she wins, which means the second player needs to say “13” or “14”, so if the first player can say “12” she wins, and so on such that if the first player can say “9”, “6”, and “3”, she can win the 21 Game. This means that if the first player goes second, she can win the game every time by saying numbers in increments of three. As such, if both players understand this strategy, then the outcome of the game is predetermined based on who goes second, which makes the game uninteresting and not requiring learned skills acquired through playing the game multiple times. Accordingly, there is a need for a math game that allows players’ skills acquired through playing the math game multiple times to improve the probability of the player winning the math game.

### SUMMARY OF THE INVENTIONS

A math game method, comprising: selecting a first set of at least two numbers by a first player; selecting a second set of at least two numbers which are different from the first set by a second player, wherein the first set and the second set of at least two numbers from the first and second players are a selected numbers; increasing one of the numbers from the selected numbers by a predetermined factor to obtain a target number that is greater than any one of the numbers within the selected numbers; providing one of the numbers from the selected numbers or a choice option in turn to the first and second players, wherein each of the numbers within the selected numbers and the choice option are given equal chance of being randomly provided in turn to the first and second players, and if one of the players is provided with the choice option, then that player can choose any of the numbers within the selected numbers; and summing the numbers provided to the players and the number chosen by the player with the choice option to calculate a new sum, and the last player to be provided with one of the numbers from the selected numbers or chosen by the choice option determines the winner of the game when the new sum is equal or greater than the target number.

### BRIEF DESCRIPTION OF THE DRAWINGS

The inventions can be better understood with reference to the following drawings and descriptions. The components in the figures are not necessarily to scale, emphasis instead being placed upon illustrating the principles of the inventions. Moreover, in the figures, like reference numerals designate corresponding parts throughout the different views.

FIG. 1 shows a flow chart illustrating steps in a game.

FIG. 2 shows a spinner.

FIG. 3A shows Table 3A.

FIG. 3B shows Table 3B.

FIG. 4A shows Table 4A.

FIG. 4B shows Table 4B.

FIG. 5 shows a flow chart illustrating the steps of another embodiment of a game.

FIG. 6A shows Table 6A.

FIG. 6B shows Table 6B.

FIG. 7A shows Table 7A.

FIG. 7B shows Table 7B.

### DETAILED DESCRIPTION OF THE INVENTIONS

The various aspect of the inventions can be better understood with reference to the drawings and descriptions described below. The components in the figures, however, are not necessarily to scale, emphasis instead being placed upon illustrating the principles of the various aspect of the inventions. The claimed invention(s) is/are not limited to apparatuses or methods having all of the features of any one apparatus or method described below or to features common to multiple or all of the apparatuses described below. The claimed inventions may reside in a combination or sub-combination of the apparatus elements or method steps described below. It is possible that an apparatus or method described below is not an example of the claimed inventions. In general, when the terms “may”, “is”, and “are” are used as a verb in the description corresponding to a particular subject matter, these terms are generally used in this disclosure as an expression of a possibility of such subject matter rather than as a limiting sense such as when the terms “shall” and “must” are used. For example, when the description states that the subject matter “may be” or “is” circular, this is one of many possibilities, such that the subject matter can also include an oval, square, regular, irregular, and any other shapes known to a person of ordinarily skilled in the art rather than being limited to the “circular” shape as described and/or illustrated in the corresponding referenced figure. In addition, when the term “may”, “is”, and “are” are used to describe a relationship and/or an action, these terms are generally used in this disclosure as an expression of a possibility. For example, when the description states that a subject matter A “may be” or “is” adjacent to a subject matter B, this can be one of many possibilities including the possibility that the subject matter A is not adjacent to the subject matter B as it would be understood by a person of ordinarily skilled in the art.

Moreover, it is within the scope of the inventions to combine the various embodiments disclosed relating to one or more particular drawing and their corresponding descriptions with one or more of other drawings and their corresponding descriptions disclosed herein and/or other references incorporated herein by reference where such a combination may be combined and practiced by one of ordinary skilled in the art. The same referenced numerals referred to in the drawings and descriptions generally correspond to the same or similar parts throughout the disclosure.

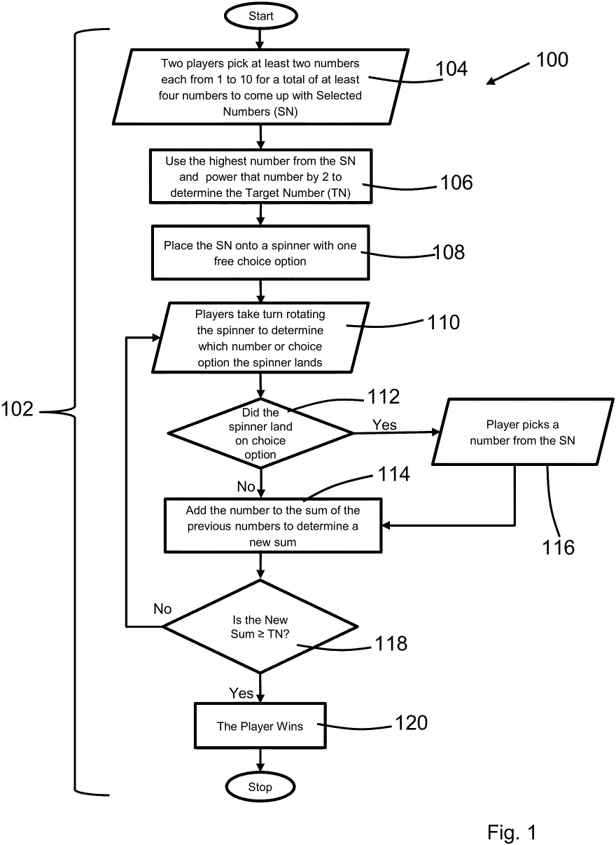

One of the aspects of the invention is to provide a math game 100 including a set of rules and a method of playing the game 100 by one or more players. In this regard, FIG. 1 shows a flow chart 102 that generally illustrates the rules and method of playing the game 100. The rules for the game 100 may include steps 104, 106, and 108. In step 104, one or more players may take turns selecting one or more numbers from 0 to a predetermined number. The combination of numbers selected by the payer(s) may be hereinafter referred to as Selected Numbers or “SN”. For instance, two players may take turns selecting two numbers from 1 to 10 for a total of four numbers. With one player, the player may play against an electronic device with an algorithm programmed into the device as discussed in this disclosure. In addition, this game may be played by more than two players such as three players each selecting one or more numbers from 1 to 10 where the upper limit of the number may increase as the number of players increases. In this disclosure, an example of two players taking turns selecting two numbers from 1 to 10 to come up the SN including four numbers may be used to illustrate the rules and the manner in which this game 100 may be played.

In step 106, the highest number within a set of the SN may be increased by a certain multiple to provide a target number (hereinafter may be referred to as “TN”). The TN may be calculated using a variety of methods such as by: (1) multiplying the highest number by a number greater than 1; (2) dividing the highest number by a number less than 1; (3) multiplying the highest number by a formula where TN is greater than the highest number; and (4) powering the highest number by a number greater than 1. In this embodiment, the highest number may be powered by 2 to get the TN. For example, if SN includes four numbers: 1, 3, 5, and 6, where the highest number is 6, then 6 may be powered by 2 such that TN is 36. As discussed in more detail below, in one of the embodiments, the TN may be used as a number that a first player to reach may win the game; and alternatively, a first player that is forced to reach that number would lose the game. That is, TN may be used as a number that determines the outcome of the game.

In step 108, the player(s) playing the game 100 may be provided with one or more number(s) as an output from SN, which may be randomly picked. Alternatively, a choice option may be added as one of the outputs along with the SN such that the choice option and the set of numbers in the SN may be given equal weight which can be randomly picked as an output to the player. As an example, if the SN includes four numbers plus a choice option, and each is given equal weight as being randomly picked, then a total of five options including the four numbers and the choice option would each have 20% chance of being picked and provided to the player. Also, if one player is playing the game 100, then the player may play against the algorithm of the game 100 where the algorithm outputs a random number within the set of numbers from SN; and if a choice option is included in the game 100, then the algorithm may randomly pick choice option along with one of the numbers from SN in a manner discussed above.

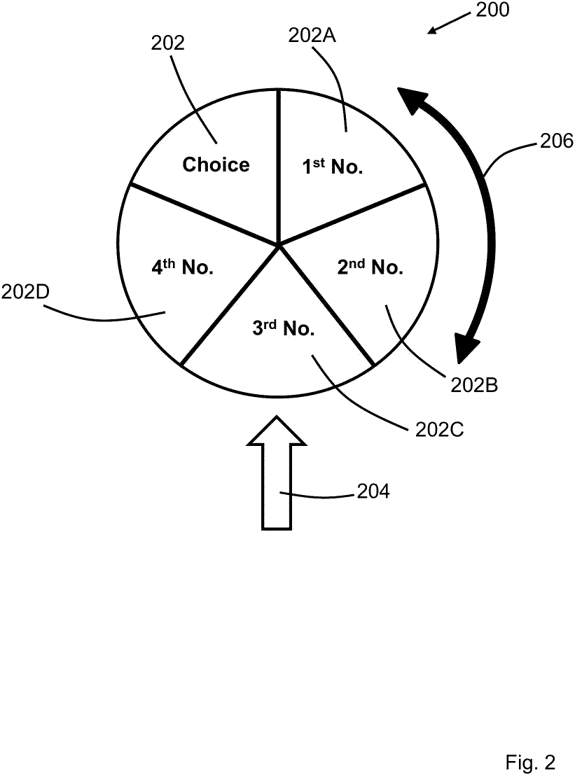

As discussed by way of the example above, the algorithm of the game 100 may randomly pick one of the numbers from SN and the choice option, and provided the picked number to the player. The algorithm may be provided in a variety of methods known to one ordinarily skilled in the art such as being embedded into an electronic device such as a gaming console or provided as an application that can be downloaded to smartphones and computers to allow one or more players to play the game 100. Alternatively, the game 100 may be provided as a traditional board game including an apparatus that randomly selects one of the numbers from SN and the choice option. In this regard, in step 108, FIG. 2 illustrates by way of example that the game 100 may include a spinner 200 with provisions for the numbers within the SN and a choice option (if the choice option is an available output). In this example, the spinner 200 may include five provisions for the SN including four numbers 202A, 202B, 202C, and 202D; and a choice option 202E, where each of the provisions may be equally divided to allow equal weight for one of the five provisions to be selected by an arrow indicator 204.

In step 110, the players may take turns rotating the spinner 200 in either direction as indicated by the direction arrow 206 to determine the outcome as indicated by the arrow indicator 204. Alternatively, the algorithm for the game 100 may be embedded into an electronic device, and the electronic device may randomly select a number from the SN or the choice option.

In step 112, a decision matrix determines if the selection in Step 110 is a number from the SN or the choice option. In step 114, if the selection from the step 110 is a number, then the selected number is added to the summation of the previous number(s) to determine a new sum. On the other hand, in step 116, if the selection from the step 110 is a choice option, then the player who spun in step 110 is allowed to pick a number from a set of SN, such as one number from 1, 3, 5, and 6 in the example provided above. Depending on the stage of the game, the player may apply the backward induction method to pick a number from the set of SN to improve the chance of winning the game. In step 114, the number picked by the player is then added to the summation of the previous number(s) to determine a new sum. In step 118, if the new sum is equal to or greater than the TN, then the last player who spun the spinner in step 110 wins the game as indicated by the step 118; otherwise, the next player takes a turn spinning in step 110, and the process as discussed above from steps 110 to 116 repeats itself until in the step 118, the new sum is equal or greater than the TN.

The following is an illustration of how the game may be played by two players, a first player and a second player, who have selected the same SN example discussed above where SN are: 1, 3, 5, and 6, such that the TN is 36. The first and second players may take turns spinning the spinner 200 which may result in the following sequence of numbers: 5, 3, 5, 1, 6, and 3, and the first player who is the last person to spin the spinner 200 results in a choice option. With such exemplary results, the first player now has an option to pick any one of the SN or 1, 3, 5, and 6 where the new sum at this stage of the game is: 5+3+5+1+6+3 = 23, which means that the difference between the TN and the new sum is 36-23 = 13. The first player has many ways to strategize to win this game, but perhaps the simplest strategy is to be the last player to spin the spinner to reach TN or 36. And one way to analyze an estimated number of turns remaining in this game is to determine the average number of the four SN, which is (1+3+5+6) ÷ 4 = 3.75; and here an assumption may be made that if a player has a choice option later in the game, and without knowing the new sum at the later stage in the game, the same average number, which is 3.75 in this example, may be assigned to the choice option. This means that the weighted average number as a result of spinning the spinner is 3.75. Given that the difference between the TN and the new sum is 13 (36-23), with the assumptions made above, the players on average may have 3.46 (13 ÷ 3.75) turns left. Note that the average spin of 3.46 means that there may be a slightly better chance that the last spin may be the third spin rather than the fourth spin since rounding off 3.46 is slightly closer to 3 than 4, where an average spin of 3.5 would have meant that a player with the third or fourth spin would have an equal chance of winning the game.

Based on the above strategy, the players may have a best chance of winning the game if each player thinks of every spin at the spinner 200 as a new game, where in this example, the new game has a starting number of 23 with the same SN and TN so the difference between the TN and new starting number 23 is 13 (36-23); and, as discussed above, the player that has the third spin at the spinner 200 may have a slightly better chance of winning the game. In this example, the first player has the third spin, and the second player has the fourth spin, and as discussed above, the third spin has a slightly better chance of being the last spin to win the game versus the fourth spin. As such, the first player may have a best chance of winning the game by strategizing to have the third spin be the last spin whereas the second player may have a best chance of winning the game by strategizing to have the fourth spin be the last spin. That is, if the first player spins the spinner 200 (first spin – assuming a new game with the starting number of 23) and gets a choice option, the first player may have a better chance of winning the game if the first player picks a number from SN that will allow the second player to spin the spinner 200 (second spin) and get a number without reaching the TN, thereby allowing the first player to have another spin (third spin) at the spinner 200 to get a third number; and minimize the chance of giving the second player a fourth spin at the game.

In this example, the first player having a choice option may have a best chance of winning the game by choosing 6 from SN since this means that the new sum will be 29 (23 + 6) and the difference is 7 between TN and new starting number (36- 29). This means that the second player cannot win with the second spin because the highest number the spinner 200 can output is 6, even with the chosen option, which means the difference is 1 between TN and the new starting number 35 (29+6), which means that the first player will get a third spin to give the first player a best chance to win the game. Note that the first player could have picked other numbers from SN such as 1, 3, and 5 but these lesser numbers would have given the second player an improved chance of getting a fourth spin which would then give the fourth player a better chance of winning the game.

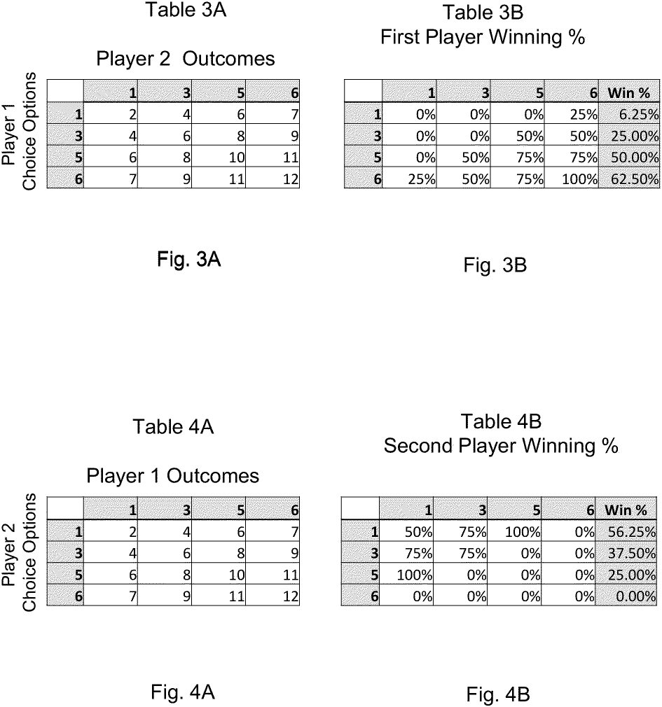

FIG. 3A shows Table 3A with SN on the left column from which the first player can choose from with the chosen option, and the top row lists the possible outcome from the second spin by the second player; and FIG. 3B shows Table 3B with possible winning percentages based on the outcomes from the Table 3A. Table 3A shows a 4 × 4 matrix with all the possible combinations of outcomes for the Choice Option the first player has with respect to the second spin the second player has with the possible SN in the top row even if the second player gets a Choice Option as well. Table 3B list the possible winning percentages for the first player for each of the combination of outcomes from Table 3A. For example, in Table 3B, if the combination from the Choice Option and the second spin by the second player results in 7, which can happen if the first player chooses 6, and the second spin by the second player results in 1; or if the first player chooses 1, and the second spin by the second player results in 6. This means that the new sum is 30 (23 + 7), which also means that the first player has 25% chance of winning in the next spin or the third spin because only one of the four SN can add to the new sum of 30 to reach the TN or 36. That is, in the third spin by the first player, if the spinner 200 results in 1, 3, or 5, then TN cannot be reached so the second player will get another spin or a fourth spin. Only if the third spin by the first player results in 6, which is one in four chance or 25% chance, can the first player reach TN or 36 (30+6) and win the game. As another example, if the combination from the Choice Option and the second spin by the second player results in 6, then the first player has no chance of winning in the third spin because the new sum is 29 (23+6) and none of the SN 1, 3, 5, and 6 will add to the new sum to reach TN. As yet another example, if the combination is 8, then the first player has 50% chance of winning in the third spin because the new sum is 31 (23+8) and two out of four numbers 5 and 6 from SN will add to the new sum to reach TN.

Table 3B lists the winning percentages of each of the combinations from the Choice Option and the second spin by the second player, and the last column under the heading “Win %” provides average winning percentages for each of the choice options based on the four possible outcomes based on the second spin by the second player. And according to the Table 3B, the first player has a best chance of winning the game by picking 6 with the Choice Option at 62.5% and less chance by picking smaller numbers: 50.0% with 5; 25% with 3; and 6.25% with 1. And this may be consistent with the strategy discussed above where the average spin of 3.46 means that there may be a slightly better chance that the last spin may be the third spin rather than the fourth spin; and for the first player, picking a higher number would improve the chance that the last spin would be a third spin rather than a fourth spin, and vice versa.

Assuming the first player picks 6 with its Choice Option for the reasons stated above, a new game starts with a new sum of 29 (23 + 6) and the difference is 7 (36- 29) between TN and the new starting number; and the second player spins the spinner 200 and also gets a Choice Option. With the assumptions made above, the players on average may have 1.86 (7 ÷ 3.75) turns left, which can be rounded off as 2.0, which means that the first player with the second spin may have a much better chance of reaching TN to win the game, unless the second player picks a number from SN that minimizes the first player from reaching TN, and allow the second player to have a third spin.

FIG. 4A shows a 4 × 4 matrix with the possible combination of outcomes for the Choice Option the second player has with respect to the second spin with the possible SN in the top row. FIG. 4B shows Table 4B, which lists the possible winning percentages for the second player for each of the combinations of outcomes from Table 4A. Note that the second player using Choice Option by choosing 1 minimizes the first player from reaching TN with its second spin, which allows the second player to have a third spin with 56.25% of winning the game. Accordingly, the players may implement the strategies discussed above such as the backward induction method and understanding with spin at the spinner 200 may be a new game, and minimizing the percentage of giving the opponent the last spin to reach TN, and thereby improving their chance of winning the game.

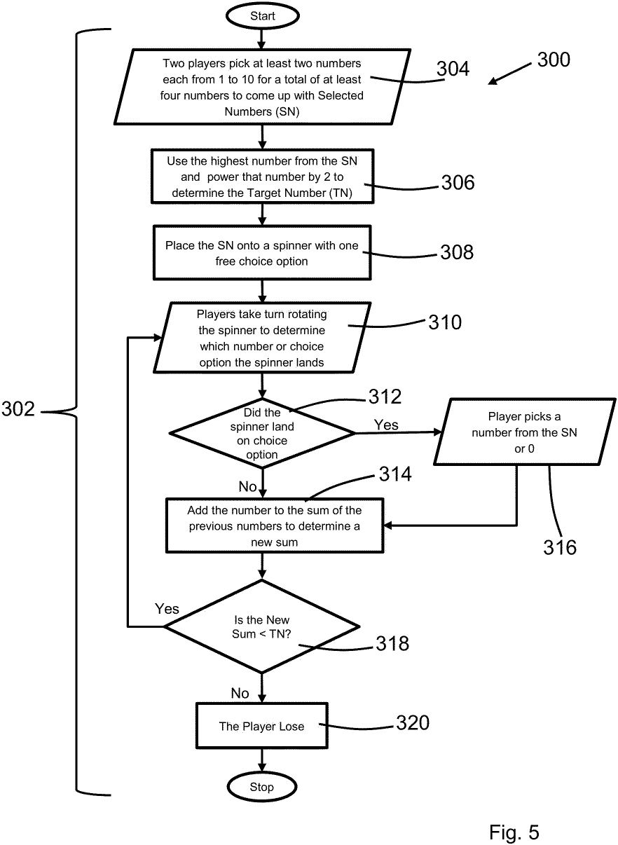

FIG. 5 shows a flow chart 300 illustrating another aspect of the inventions to provide a math game 300 where the player that reaches or exceeds the TN first may lose the math game 300. The math game 300 may include a set of rules and a method of playing the game 300 by one or more players, which may be similar to the math game 100 except for the following steps 316, 318, and 320. In this regard, in FIG. 5, the steps 304 through 314 may be similar to the steps 104 through 114 discussed above in reference to FIG. 1. Assuming the SN are same 1, 3, 5, and 6 as the example discussed above, in step 316, if the selection from the step 310 is a choice option, then the player who spun in step 310 may be allowed to pick a number from a set of SN, such as one of the SN from 1, 3, 5, and 6, or 0. In the game 300, a player is allowed an option to pick zero (0) to avoid reaching the TN as discussed in more detail below. Depending on the stage of the game, the player may apply the backward induction method to pick a number from SN or 0 to improve the chance of not reaching the TN before the opponent. In step 314, the number picked by the player is then added to the summation of the previous number(s) to determine a new sum. In step 318, if the new sum is less than the TN, then the last player who spun the spinner in step 310 is allowed to continue to play the game 300 to avoid losing the game 300. On the other hand, in step 320, if the new sum from the last player who spun the spinner 200 is equal to greater than the TN, then the player loses the game 300.

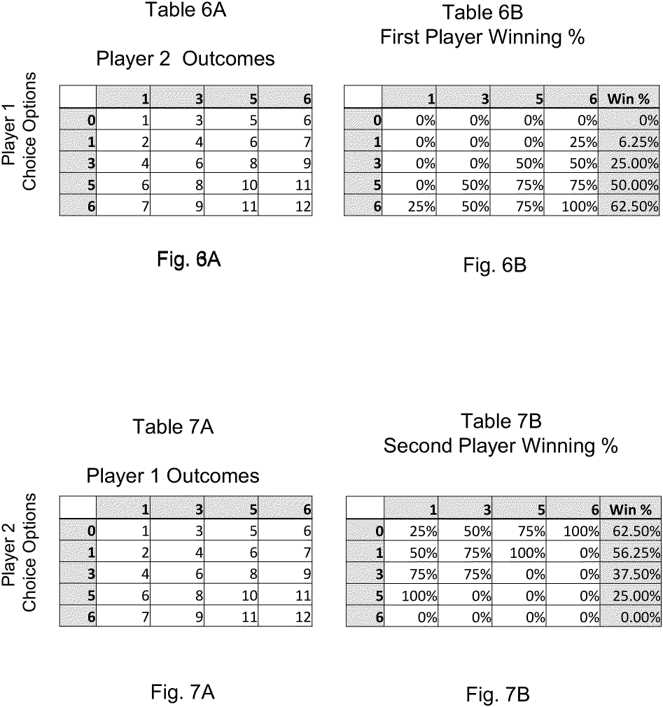

FIG. 6A shows Table 6A with SN and 0 on the left column from which the first player can choose from with the chosen option, and the top row lists the possible outcome from the second spin by the second player; and FIG. 6B shows Table 6B with possible winning percentages based on the outcomes from the Table 6A. Assuming the same example discussed above in reference to the Table 3A, where the new sum is 23, when playing the math game 300, Tables 6A and 6B includes an option for 0 for the first player with the possible outcomes; and Table 6B lists the corresponding percentages of reaching the TN. Again, in game 300, the goal is to have the opponent reach the TN first to win the game. With this objective, the first player’s best option may be picking 0 since this gives the first player 0% chance of reaching the TN.

FIG. 7A shows Table 7A with SN and 0 on the left column from which the second player can choose from with the chosen option, and the top row list the possible outcome from the second spin by the first player; and FIG. 7B shows Table 7B with possible winning percentages based on the outcomes from the Table 7A. Assuming the same example discussed above in reference to the Table 4A, where the new sum is 29, when playing the math game 300, Tables 7A and 7B includes an option for 0 for the second player with the possible outcomes; and Table 7B lists the corresponding percentages of reaching the TN. With the first player’s objective of having the first player reach or exceed TN first, the second player’s best option may be picking 6 since this gives the second player 0% chance of reaching the TN.

While various embodiments of the inventions have been described, it will be apparent to those of ordinary skill in the art that many more embodiments and implementations are possible within the scope of these inventions. Moreover, various features and functionalities described in this application and Figures may be combined individually and/or a plurality of features and functionalities with others. Accordingly, the invention(s) is/are not to be restricted except in light of the attached claims and their equivalents.

What is claimed is:

1. A math game method, comprising:
selecting a first set of at least two numbers by a first player;
selecting a second set of at least two numbers which are different from the first set by a second player, wherein the first set and the second set of at least two numbers from the first and second players are selected numbers;
increasing one of the numbers from the selected numbers by a predetermined factor to obtain a target number that is greater than any one of the numbers within the selected numbers;
providing one of the numbers from the selected numbers or a choice option in turn to the first and second players, wherein each of the numbers within the selected numbers and the choice option are given equal chance of being randomly provided in turn to the first and second players, and if one of the players is provided with the choice option, then that player can choose any of the numbers within the selected numbers; and
summing the numbers provided to the players and the number chosen by the player with the choice option to calculate a new sum, and one of the first and second players that is last to be provided with one of the numbers from the selected numbers or chosen by the last player with the choice option determines the winner of the game when the new sum is equal or greater than the target number.

2. The method according to claim 1, wherein when the new sum is equal or greater than the target number, the last player to spin the spinner wins the game.

3. The method according to claim 1, wherein when the new sum is equal or greater than the target number, the last player to spin the spinner loses the game.

4. The method according to claim 1, wherein the choice option includes choosing from any of the numbers within the selected numbers or zero.

5. The method according to claim 1, wherein the step of providing is a spinner with equal spacing for each of the numbers from the selected numbers and the choice option and spinning the spinner results in one of the numbers or the choice option.

6. The method according to claim 1, wherein the step of providing is an electronic device that randomly picks one of the numbers from the selected numbers or the choice option.

7. The method according to claim 1, wherein the step of providing is a smart phone that randomly picks one of the numbers from the selected numbers or the choice option.

8. The method according to claim 1, wherein the second player is an electronic device with the game in accordance with the method embedded therein to allow the first player to play the game against the electronic device.

9. The method according to claim 1, wherein the step of selecting the first and second sets of numbers from the first and second player is from 0 to 10.

10. The method according to claim 1, wherein the step of increasing is multiplying the highest number from the selected numbers by itself to get the target number.

11. The method according to claim 1, wherein the step of increasing is multiplying the highest and the second highest numbers from the selected numbers together.

12. A math game method, comprising:
providing one of the numbers from a set of selected numbers or a choice option in turn to players, wherein each of the numbers within the selected numbers and the choice option are given equal chance of being randomly provided in turn to the players, and if one of the players is provided with the choice option, then that player can choose any of the numbers within the selected numbers; and
summing the numbers provided to the players and the number chosen by the player with the choice option to calculate a new sum, and the last player to be provided with one of the numbers from the selected numbers or chosen by the choice option determines the winner of the game when the new sum is equal or greater than the target number.

13. The method according to claim 12, wherein when the new sum is equal or greater than the target number, the last player to spin the spinner wins the game.

14. The method according to claim 12, wherein when the new sum is equal or greater than the target number, the last player to spin the spinner loses the game.

15. The method according to claim 12, wherein the choice option includes choosing from any of the numbers within the selected numbers or zero.

16. The method according to claim 12, further including:
selecting a first set of at least two numbers by a first player;
selecting a second set of at least two numbers which are different from the first set by a second player, wherein the first set and the second set of at least two numbers from the first and second players are the set of selected numbers.

17. The method according to claim 12, further including increasing one of the numbers from the selected numbers by a predetermined factor to obtain a target number that is greater than any one of the numbers within the selected numbers.

18. The method according to claim 12, wherein the step of providing is a spinner with equal spacing for each of the numbers from the selected numbers and the choice option and spinning the spinner results in one of the numbers or the choice option.

19. The method according to claim 12, wherein the step of providing is an electronic device that randomly picks one of the numbers from the selected numbers or the choice option.

20. The method according to claim 12, wherein the step of providing is a smart phone that randomly picks one of the numbers from the selected numbers or the choice option.

21. The method according to claim 12, wherein the second player is an electronic device with the game in accordance with the method embedded therein to allow the first player to play the game against the electronic device.

22. The method according to claim 12, wherein the step of selecting the first and second sets of numbers from the first and second player is from 0 to 10.

23. The method according to claim 12, wherein the step of increasing is multiplying the highest number from the selected numbers by itself to get the target number.

24. The method according to claim 12, wherein the step of increasing is multiplying the highest and the second highest numbers from the selected numbers together.
